(19) United States
(12) Patent Application Publication
(10) Pub. No.: US 2018/0229684 A1
(43) Pub. Date: Aug. 16, 2018

(54) PROTECTION FOR MOVING EQUIPMENTS AND OBJECTS

(71) Applicant: Kiomars Anvari, Walnut Creek, CA (US)

(72) Inventor: Kiomars Anvari, Walnut Creek, CA (US)

(21) Appl. No.: 15/888,175

(22) Filed: Feb. 5, 2018

Related U.S. Application Data
(63) Continuation of application No. 62/458,626, filed on Feb. 14, 2017.
Application No. 62/458,626 is a continuation of application No. 62/470,523, filed on Mar. 13, 2017.
Application No. 62/470,523 is a continuation of application No. 15/861,589, filed on Jan. 3, 2018.

(51) Int. Cl. B60R 21/233; B60R 21/268; B60R 21/013; B60R 21/231; B60R 21/01; B60R 21/26

(52) U.S. Cl. CPC B60R 21/233; B60R 21/268; B60R 21/013; B60R 2021/01286; B60R 2021/01231; B60R 2021/23332; B60R 2021/26094; B60R 2021/23107

(57) ABSTRACT

This patent application discloses a protection system using one of multilayer airbag, expandable pads, and compressed air for moving and flying vehicles and equipments. The multilayer airbag consists of a number of independent airbags within one another which will be inflated with a time sequence or simultaneously. This type of protection system can be used for various moving vehicles and equipment to protect them from any force due to a predicted impact.

The application claims priority to the following related applications and included here is as a reference.

Provisional application: U.S. patent application No. 62/458,626 filed Feb. 14, 2017, and entitled “PROTECTION GEAR FOR FLYING OBJECTS”.

Provisional application: U.S. patent application No. 62/470,523 filed Mar. 13, 2017, and entitled “EXTERNAL PROTECTION FOR MOVING VEHICLES”.

Application: U.S. patent application Ser. No. 15/861,589 filed Jan. 3, 2018, and entitled “MULTILAYER AIRBAG”.

### BACKGROUND

Developing intelligent transportation systems which take into consideration the economical, environmental, and safety factors of the modern society, is one of the main challenges of this century. Progress in the fields of mobile robots, control architectures, advanced technologies, and computer vision allows us to now envisage the integration of autonomous and driving-assistance capabilities within future vehicles. Research concerning the development of self contained unmanned vehicles robot cars is currently being carried out on a very active scale. The existing types of unmanned vehicle are designed so that the travel sections thereof are equipped with wheels crawlers etc and in which the travel motion is accomplished under the control of a control section.

Smart environments represent the next evolutionary development step in industries such as construction, manufacturing, transportation systems and even in sporting goods equipment. Like any functioning organism, the smart environment relies first and foremost on sensory data from the real world. Sensory data comes from multiple sensors of different modalities in distributed locations. The smart environment needs information about all of its surroundings as well as about its internal workings.

The challenge is determining the prioritized hierarchy of: (1) detecting the relevant quantities, (2) monitoring and collecting the data, (3) assessing and evaluating the information, and (4) performing decision-making actions. The information needed by smart environments is provided by Distributed Sensor Systems, which are responsible for sensing as well as for the first stages of the processing hierarchy.

The drive to minimize human interaction in transportation vehicles is stronger than ever, especially in public transportation, automobiles, and etc. For instant, just a few years ago, automobiles seldom had very sophisticated safety systems. Now, it is rare to find an automobile without various safety and protection systems. And now new technology is evolving to the point of being able to offer preventive methods to better manage and dissipate sudden impact energy to the vehicle.

The use of radars in collision avoidance systems is generally known. U.S. Pat. No. 4,403,220 dated Sep. 6, 1983 discloses a radar system adapted to detect relative headings between aircraft or ships at sea and a detected object moving relative to the ground. The system is adapted to collision avoidance application. U.S. Pat. No. 4,072,945 dated Feb. 7, 1978 discloses a radar-operated collision avoidance system for roadway vehicles. The system senses the vehicle speed relative to an object and its distance and decides whether the vehicle is approaching the object at a dangerously high speed. A minimum allowable distance represented by a digital code is stored in a memory of a computer and the minimum allowable distance is compared with the distance sensed by the radar. U.S. Pat. No. 4,626,850 dated Dec. 2, 1986 discloses a dual operational mode vehicle detection and collision avoidance apparatus using a single active or passive ultrasonic ranging device. The system is particularly adapted to scan the rear and the lateral sides of the motor vehicle to warn the vehicle user of any danger when changing lanes.

Most of the prior art collision avoidance systems use microwave radars as the ranging and detecting device. There are multiple problems of these automobile collision avoidance systems when microwave radars are used. One major issue is related to the beam width that is the angular width of the main lobe of the radar, and the associated angular resolution of the microwave radar. The beam width is inversely proportional to the antenna diameter in wavelength. With the limitation of the antenna size, it is very difficult to make reasonable size microwave radar with beam width less than 3 degrees. At the desired scanning distance, this beam width will scan an area which is much too big and thus is too nonspecific and difficult to differentiate the received echoes. Besides getting echo from another car in front of it, this radar will also receive echoes from roadside signs, trees or posts, or bridges over passing an expressway. On highways with divided lanes the microwave radar will receive echoes from cars 2 or 3 lanes away and has difficulty in differentiating them from echoes coming from objects in the same lane. Because of the poor angular resolution of microwave radars, the direction of objects cannot be specifically determined and objects too close to one another cannot be separated. The angular resolution of microwave radars is not small enough for them to be effectively used to monitor roadway traffic. The other issue is that the microwave radars have difficulty in distinguishing radar signals coming from adjacent cars with similar equipment. If there are more than two cars with the same radar equipment on the same scene, the signals become very confusing.

The ultrasonic ranging and detecting device's angular resolution is also too poor to be effectively used in roadway traffic monitoring. The ultrasonic devices have even more problems than the microwave radars in determining the direction and location of echoes precisely, in the detection of directional change of objects and in avoiding signals coming from adjacent vehicles with similar equipment

Systems and devices for collision avoidance of air, sea and ground vehicles are in general well known. Early devices utilized forward looking antennae with radio frequency transmitters and receivers. In U.S. Pat. No. 3,891,966 Sytankay disclosed a laser system designed to avoid rear end collisions between automobiles. This apparatus provides a laser transmitting and receiving system and a detection system mounted on the front and rear of automobiles. The transmitter at the front end emits a signal having a designated wavelength f1 and the receiver at the front end receives signals having a designated wavelength f2. Upon reception of signals of wavelength f1 the modulator at the rear end of a leading car would activate the transmitter which would send a return signal of wavelength f2 to the receiver at the front end of the trailing car. This signal is interpreted by circuits in the receiver and furnishes a warning of the proximity of the vehicles.

Sterzer et al in U.S. Pat. No. 4,003,049 shows a frequency modulated continuous wave collision avoidance radar responsive to both reply signals from cooperating tagged targets and to skin reflections from proximate non cooperating non tagged targets. German Patent No 2,327,186 and U.S. Pat. No. 4,101,888 to Heller et al describe a system in which detections are limited to the electronic road channel in which the vehicle is traveling. The radar has two antennas which radiate RF signals of different frequencies. The signals received by one of the two antennas are evaluated by determining the difference between the amplitudes of the RF signals reflected from an object. A signal proportional to the difference is then compared to a threshold proportional to a predetermined azimuth range so that cars moving in the same road lane may by discriminated against other passing objects.

More recent devices employ a millimeter wave antenna capable of electronic scanning. An example is shown in U.S. Pat. No. 5,264,859 to Lee et al in which a linear ferrite loaded slot array illuminates a dielectric lens. Beam scanning is achieved by controlling a bias magnetic field along the ferrite rod of the slot array. More advanced systems might employ a conformal array disposed within or around car structures such as bumpers. Such antenna systems are generally taught by Special in U.S. Pat. No. 5,512,906. A more complete total avoidance system is discussed by Shaw et al in U.S. Pat. No. 5,314,037. Here the laser detection system is coupled to both warning and automatic car control devises such as steering and braking systems in order to take evasive action. Obviously such complex systems are expensive to build and will have a lower inherent reliability. Although the above systems may find utility in avoiding front and rear collisions they are not adapted for early warning of imminent side collisions.

The above techniques and solution can also be applied for flying objects or any moving equipment such as drones, flying cars, robots, and in general moving equipment and flying equipments.

One effective and novel ways of minimizing collision and maximizing safety is to monitor the environment and to predict the impact using distributed sensors. Distributed sensors estimate and calculate environmental parameters related to external object. Therefore, as shown in FIG. 1a the information collected by wireless sensors and other type of sensors such as image sensors, heat sensors, speed sensors, acceleration sensors, ultrasonic sensors, proximity sensors, pressure sensors, G sensors, and IR (infrared) sensors could be used for a variety of applications. One application is to help navigation of the vehicle and minimizes driver interference or even facilitates vehicle navigation without a driver. Another application is to provide warning for driver of the vehicle. The collected information could also be used to activate certain devices like expandable pads, airbags, or compressed air before an impact occurs. This feature can be used both internal and external to the moving object. The airbags or expandable pads can be mounted on external body of vehicle and activated before the impact to absorb the force of impact for both protection of vehicle and its passengers. The wireless sensors collect the required information in presence of other vehicles which are equipped with the same technology. This requires establishment of a standard for wireless sensors used for vehicles application so that all vehicles use the same technology. This way every vehicle can be assigned a unique identification address similar to an IP address to be used by wireless sensor. By applying this technique and additional artificial intelligence any interference between wireless sensors used in all vehicles present in near vicinity can easily be avoided and usable information gathered in timely manner.

For flying objects two of possible protection gears are airbag and compressed gas systems. Airbags have evolved with regards to design, fabric and the components that go into making it. Compressed gas (air) systems are in nearly most industrial facilities around the world.

Compressed air is air kept under a pressure that is greater than atmospheric pressure. In industry, compressed air is so widely used that it is often regarded as the fourth utility, after electricity, natural gas and water. However, compressed air is more expensive than the other three utilities when evaluated on a per unit energy delivered basis. Compressed air is used for many purposes, including:

Railway breaking system: A railway air brake is a railway brake power braking system with compressed air as the operating medium.
Road vehicle breaking system: An air brake or, more formally, a compressed air brake system, is a type of friction brake for vehicles in which compressed air pressing on a piston is used to apply the pressure to the brake pad needed to stop the vehicle.
Air guns: An air gun is any kind of small arms that propels projectiles by means of mechanically pressurized compressed air or other gas (shooting involves no chemical reaction), in contrast to explosive propellant of a firearm.

An airbag is made up of three parts. The first part is the bag itself that is made out of thin nylon fabric and is folded in the steering wheel or the dashboard of a car. The second part of the airbag is the sensor that informs the bag to inflate when the car meets with an accident. The sensor detects the collision force and calculates the force equal to running into a brick wall at around 10 to 15 miles per hour. The third part consists of an inflation system.

The airbags are inflated using sodium azide and potassium nitrate. When any collision takes place, the sensor detects the collision force and informs the bag to inflate. At that time, the sodium azide and potassium nitrate react quickly and produces a large pulse of hot nitrogen gas. The gas inflates the bag in turn and the bag literally bursts out of the steering wheel or the dash board. After a second, the bag starts deflating with the help of the holes present on it to get out of your way.

Expandable pads are made of polymers that can be expanded by applying voltage to two ends of the pads. The pad after activation need to be replaced.

This patent application discloses a protection system using one of multilayer airbag, expandable pads, and compressed air for moving and flying vehicles and equipments. The multilayer airbag consists of a number of independent airbags within one another which will be inflated with a time sequence or simultaneously. This type of protection system can be used for various moving vehicles and equipment to protect them from any force due to a predicted impact.

### BRIEF DESCRIPTION OF THE DRAWINGS

FIG. 1a illustrate a typical scenarios for moving vehicles

FIG. 1b depicts a moving vehicle or equipment using expandable pads and multilayer airbags for protection

FIG. 2 depicts a flying vehicle or equipment using compressed air and multilayer airbag for protection

FIG. 3 shows a multilayer airbag system

FIG. 4 depicts an embodiment of an expandable pad

FIG. 5 depicts an embodiment of a method for using multilayer airbag to protect a moving objects

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

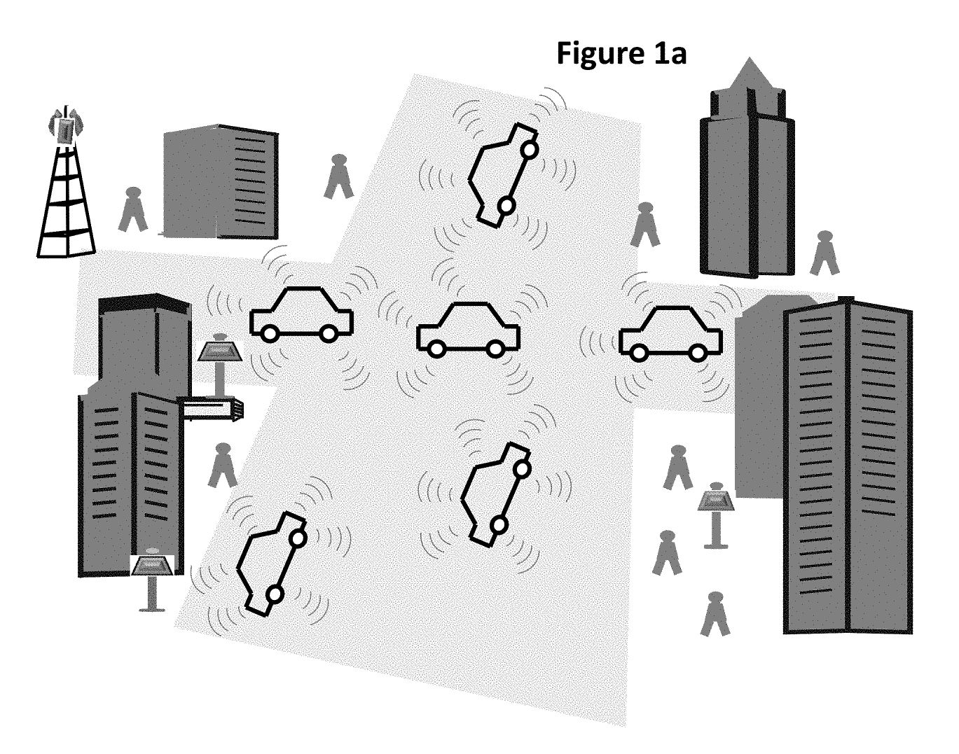

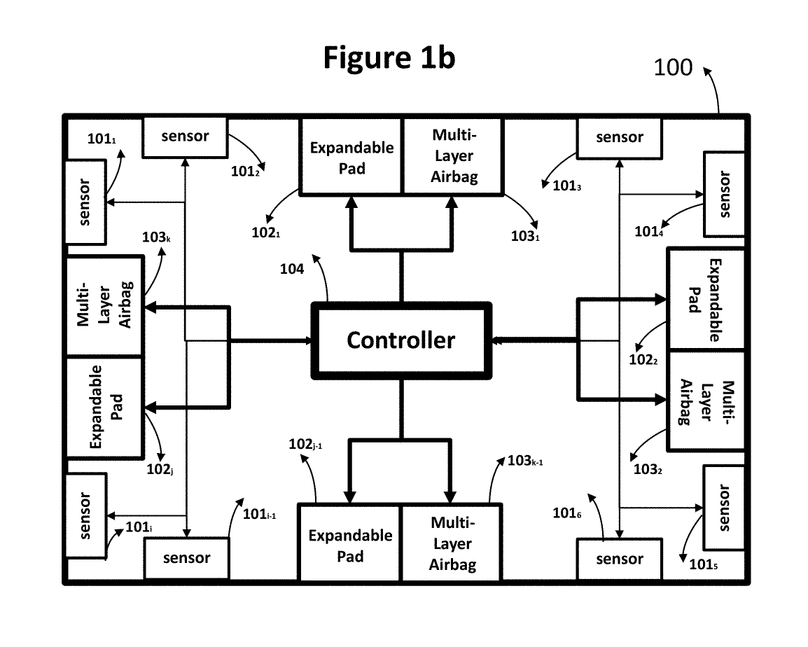

FIG. 1b illustrates an embodiment of a vehicle/object 100. In general, the vehicle/object 100 provides external body protection by applying voltage to two ends of an expandable pad and/or inflating a multilayer airbag. The controller 104 receives information data related to operation status and surrounding environment parameters of the vehicle/object 100 from sensors 101₁ to 101ᵢ to detect any malfunction of the vehicle/object 100 or approaching of external objects that results in an impact. When controller 104 detects a potential impact based on its artificial intelligence analyses of the information data received from sensors 101₁ to 101ᵢ which include information data related to internal devices and surrounding environment parameters, it activates one or more of the expandable pads 102₁ to 102ⱼ and/or activates one or more of the multilayer airbag 103₁ to 103ₖ to minimize the damage to the vehicle/object 100.

Vehicle/object 100 includes, among other things, sensors 101₁ to 101ᵢ, controller 104, expandable pads 102₁ to 102ⱼ, and multilayer airbags 103₁ to 103ₖ.

In one embodiment of the vehicle/object 100, multiple expandable pads 102₁ to 102ⱼ and multiple multilayer airbags 103₁ to 103ₖ are mounted on all external sides of vehicle/object 100 and provide protection for impacts due to external objects on any external side of vehicle/object 100.

In one embodiment of the vehicle/object 100, the expandable pads 102₁ to 102ⱼ and multilayer airbags 103₁ to 103ₖ are mounted on the main body frame of the vehicle/object 100 to provide a firm and strong support.

In one embodiment of the vehicle/object 100, by activating the expandable pads 102₁ to 102ⱼ and/or multilayer airbags 103₁ to 103ₖ the impact force to vehicle/object 100 will be lowered by absorption or diffraction and provides more protection to the passengers of vehicle/object 100 if any.

In one embodiment of the vehicle/object 100, one or more of the multilayer airbags 103₁ to 103ₖ at one or multiple sides of the vehicle/object 100 can be inflated to protect the external of vehicle/object 100 from fall, crash or impact with an external object.

In one embodiment of the vehicle/object 100, one or more of the expandable pads 102₁ to 102ⱼ at one or multiple sides of the vehicle/object 100 can be expanded by applying voltage to two ends of expandable pad to protect the external of vehicle/object 100 from fall, crash or impact with an external object.

In one embodiment of the vehicle/object 100, controller 104 resets, and configures itself based on configuration data stored in its memory and then starts executing the artificial intelligence executable software which controls all aspects of navigation and protection of the vehicle/object 100 using information data provided by sensors 101₁ to 101ᵢ.

In one embodiment of the vehicle/object 100, multiple sensors 101₁ to 101ᵢ are distributed at various locations internal and external to vehicle/object 100 and each has an IP address which is used to avoid collision or confusion of the information data received by the controller 104 from said sensors internal or external to the vehicle/object 100.

In one embodiment of the vehicle/object 100, the sensors 101₁ to 101ᵢ can be at least one of image sensor, wireless sensor (radar), heat sensor, speed sensor, acceleration sensor, ultrasonic sensor, proximity sensor, pressure sensor, G sensor, and IR (infrared) sensor.

In one embodiment of the vehicle/object 100, a wireless sensor (radar) transmits a coded signal similar to an identity code, or an IP address and receives the reflected signal from objects in surrounding environment of the vehicle/object 100 to avoid collision with signals from other vehicles or objects.

In one embodiment of the vehicle/object 100, two or more type of sensors can be used to better monitor the surrounding environment of the vehicle/object 100 and calculate and estimate parameters of the vehicle/object 100 surrounding environment.

In one embodiment of the vehicle/object 100, a wireless sensor with IP address and an image sensor are used to monitor the vehicle/object 100 surrounding environment, calculate and estimate the distance and approaching speed of objects in the surrounding environment and use the information data to make a better decision to activate a multilayer air bag and/or an expandable pad.

In another embodiment, the vehicle/object 100 can be an automobile, a robot, a flying car, a small plane, a drone, a glider, a human or any flying and moving object/device/equipment.

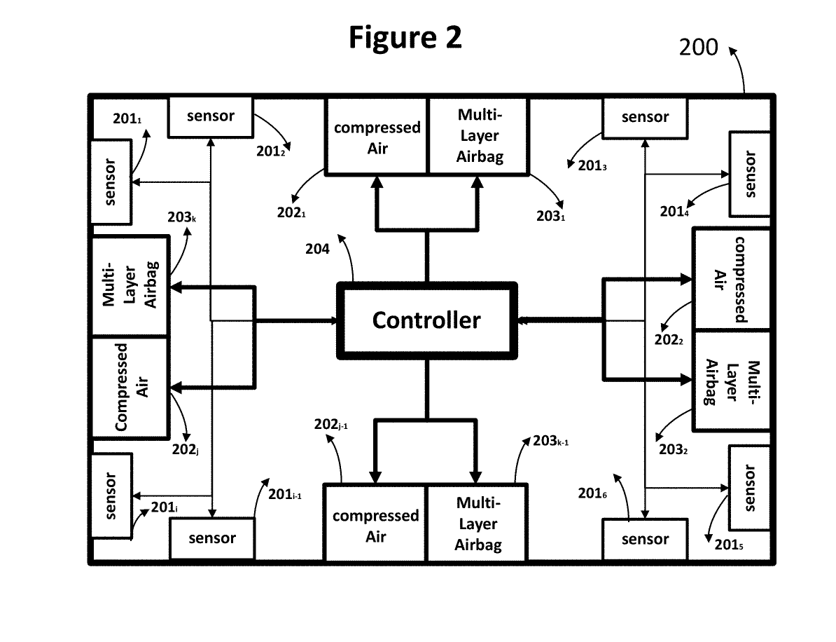

FIG. 2 illustrates an embodiment of a flying object 200. In general, the flying object 200 provides protection by releasing compressed air and/or inflating a multilayer airbag. The controller 204 receives information data related to operation status and surrounding environment of the flying object 200 from sensors 201₁ to 201ᵢ to detect any malfunction of the flying object 200 that results in loss of altitude, vertical fall due to gravity force and eventual crash to the ground. When controller 204 detects a fall through its artificial intelligence which analyses the information data received from sensors 201₁ to 201ᵢ which include information data related to devices internal to flying object 200 and its surrounding environment parameters, it activates at least one of the compressed air 202₁ to 202ⱼ to release air to slow down the fall at certain distance from ground before the flying object 200 crashes and then activates one or more of the multilayer airbag 203₁ to 203ₖ for smoother landing or crash.

Flying object 200 includes, among other things, sensors 201₁ to 201ᵢ, controller 204, compressed air units 202₁ to 202ⱼ, and multilayer airbags 203₁ to 203ₖ.

In one embodiment of flying object 200, a subset of compressed air units 202₁ to 202ⱼ and multilayer airbags 203₁ to 203ₖ allow for smoother crash or landing on any side of the flying object 200.

In one embodiment of flying object 200, a centralized compressed air unit with multiple outlets at different sides of the flying object can be used and the air is released only from the outlets on the side that flying object 200 lands or crash to the ground.

In one embodiment of flying object 200, one or more of the multilayer airbags 203₁ to 203ₖ at one or multiple sides of the flying object 200 can be inflated to make the crash or landing as smooth as possible.

In one embodiment of flying object 200, controller 204 resets, and configures itself based on configuration data stored in its memory and then starts executing the artificial intelligence software which controls all aspects of navigation and protection of the flying object 200 using information data provided by sensors 201₁ to 201ᵢ.

In one embodiment of flying object 200, each sensor of flying object 200 has an IP address which is used to avoid collision or confusion of the information data received by the controller from sensors internal or external to the flying object.

In one embodiment of flying object 200, each sensor of flying object 200 sends its information data to the controller by using wireless and/or wired communication.

In one embodiment of flying object 200, the sensors 201₁ to 201ᵢ can be at least one of image sensor, wireless sensor (radar), heat sensor, speed sensor, acceleration sensor, ultrasonic sensor, proximity sensor, pressure sensor, G sensor, and IR (infrared) sensor.

In another embodiment, the flying object 200 can be a drone, a flying car, a small plane, a glider, and a human.

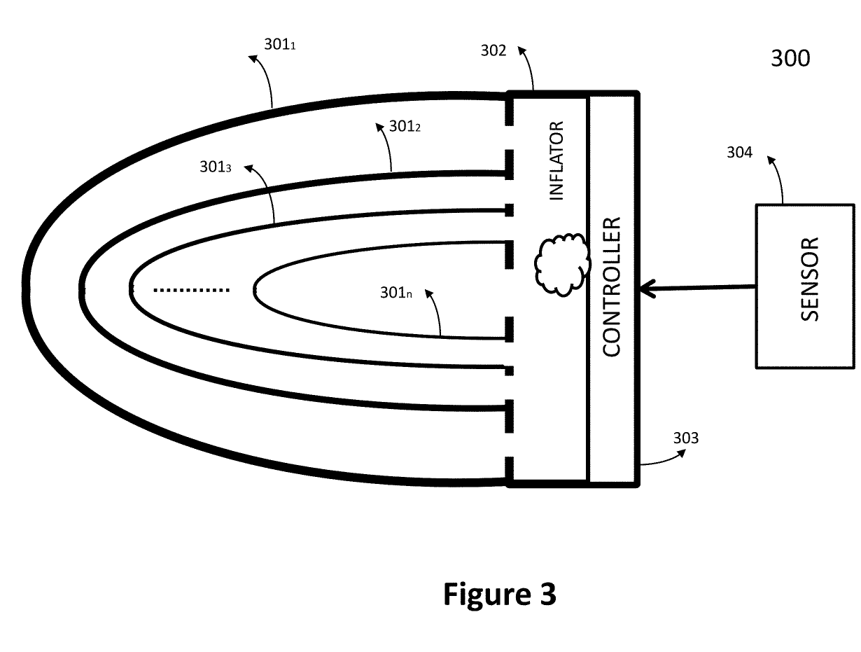

FIG. 3 illustrates an embodiment of a multilayer airbag protection system 300. In general, the multilayer airbag protection system 300 provides protection by inflating “n” airbags that are within one another. When sensor 304 detects an approaching object to the multilayer airbag protection system, it sends a detection information data to the controller 303. The controller 303 based on the detection information data and other available data decides to activate the inflator 302 to inflate airbags 301₁ to 301ₙ.

Multilayer airbag protection system 300 includes, among other things, sensor 304, controller 303, inflator 302, and “n” airbags 301₁ to 301ₙ that are within each other.

In one embodiment, the sensor 304 can be at least one of image sensor, wireless sensor (radar), heat sensor, speed sensor, acceleration sensor, ultrasonic sensor, proximity sensor, pressure sensor, G sensor, and IR (infrared) sensor.

In one embodiment of multilayer airbag protection system 300, the controller 303 provides the firing driver for the inflator 302 gas generator, monitors operation of the multilayer airbag, and indicates any malfunction.

In one embodiment of multilayer airbag system 300, the inflator 302 inflates multilayer airbag 301₁ to 301ₙ based on the activation command it receives from controller 303 by producing a large pulse of hot nitrogen gas.

In one embodiment of multilayer airbag system 300, the airbag 301₂ resides inside airbag 301₁, the airbag 301₃ resides inside airbag 301₂, and ultimately airbag 301ₙ resides inside airbag 301ₙ₋₁.

In one embodiment of multilayer airbag system 300, the airbag 301₂ inflates within airbag 301₁, the airbag 301₃ inflates within airbag 301₂, and ultimately airbag 301ₙ inflates within airbag 301ₙ₋₁.

In one embodiment, the multilayer airbag 301₁ to 301ₙ provide “n” layer of redundancy.

In one embodiment of multilayer airbag 300, the controller 303 activates the inflator 302 based on at least one of the information data it receives from the sensor 304, the central brain or artificial intelligence (AI) of the equipment or gear that uses multilayer airbag 300, and other entities (for example an operating person).

In one embodiment of multilayer airbag 300, the controller 303 acts as the main brain or artificial intelligence and activates the inflator 302 based on the information data it receives from the sensor 304 and other sensors of the equipment or gear that uses multilayer airbag 300.

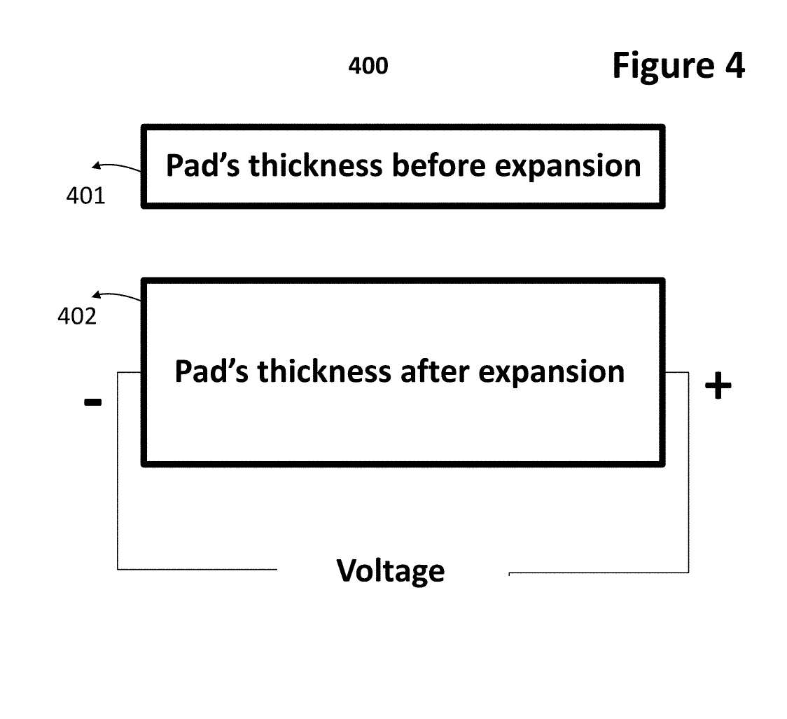

FIG. 4 shows an embodiment of expandable pad 400. In general expandable pad 400 is a polymer that expands when a voltage is applied at its two ends.

The expandable pad 400 includes, among other things a voltage generator which applies a defined voltage across two ends of the pad.

In one embodiment of expandable pad 400, the pad 401 consists of a polymer with certain thickness.

In one embodiment of expandable pad 400, the pad 402 is the pad 401 when expanded after a voltage is applied to its two ends to increased and expanded its thickness.

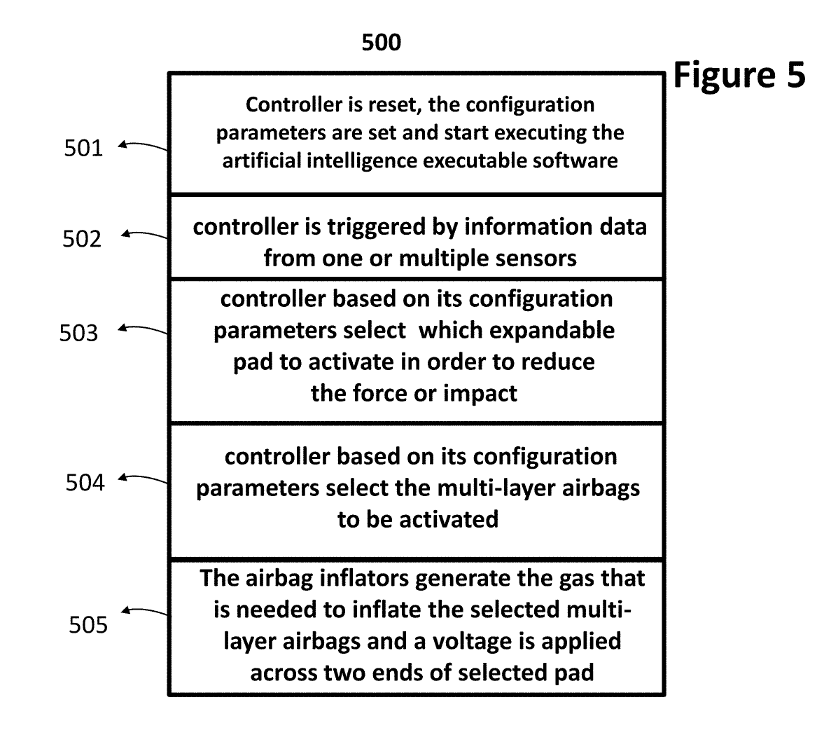

FIG. 5 depicts an embodiment of method 500 for using multilayer airbag and expandable pad to protect a vehicle/object. In various embodiments, method 500 is carried out by sensor, expandable pads, multilayer airbag and controller under the control of processes or executable instructions. The readable and executable instructions reside, for example, in a data storage medium such as processor usable volatile and non-volatile memory. However, the readable and executable instructions may reside in any type of processor readable storage medium. In some embodiments, method 500 is performed at least by one of the circuits described herein.

At 501 of method 500, Controller is reset; the configuration parameters are set and start executing the artificial intelligence executable software.

At 502 of method 500, controller using its artificial intelligence executable software analyses the information data from one or multiple sensors to detect any potential or imminent impacts due to approaching objects, falling, or crash.

At 503 of method 500, the controller based on its configuration parameters select which expandable pad and/or compressed air to activate in order to reduce the force due to impact.

At 504 of method 500, the controller based on its configuration parameters selects the multilayer airbags to be inflated and activates the inflators of the airbags.

At 505 of method 500, the airbag inflators generate the gas that is needed to inflate the selected multilayer airbags and a voltage is applied across two ends of selected pads.

Various embodiments are thus described. While particular embodiments have been described, it should be appreciated that the embodiments should not be construed as limited by such description, but rather construed according to the following claims.

1. A vehicle with external protection comprising:
a plurality of sensors installed at location internal and external to the body of said vehicle to provide an information data related to the operation of vehicle and vehicle's surrounding environment parameters for a controller to process;
a plurality of multilayer airbags installed on the external body of said vehicle;
said controller to monitor said information data and decide when to activate at least one multilayer airbag from said plurality of multilayer airbags;
said vehicle is at least one of an automobile, a robot, a flying car, a drone, a small plane, a glider, a human and a moving object/device/equipment.

2. The vehicle of claim 1, wherein a sensor within said plurality of sensors is at least one of an image sensor, a wireless sensor (radar) with IP address or identity code, a heat sensor, a speed sensor, an acceleration sensor, an ultrasonic sensor, a proximity sensor, a pressure sensor, a G sensor, and an IR (infrared) sensor.

3. The vehicle of claim 1, wherein said sensors are distributed at various locations internal and external to said vehicle, each has an identity code like IP address which is used to avoid collision or confusion with any information data from other sensors, and each uses at least one of wireless or wired communication to send its information data to the controller.

4. The vehicle of claim 1, wherein said wireless sensor (radar) transmits a coded signal similar to an identity code, or an IP address and receives the reflected signal from objects in surrounding environment of the vehicle to avoid collision with signals from other vehicles or objects.

5. The vehicle of claim 1, wherein multiple of said sensors can be used to better monitor the surrounding environment of the vehicle and calculate and estimate parameters of the vehicle's surrounding environment.

6. The vehicle of claim 1, wherein said controller configures itself based on a configuration data stored in its memory and then executes an artificial intelligence executable software which controls all aspects of navigation and protection of the vehicle.

7. The vehicle of claim 1, wherein two or more type of said sensors is used to better monitor the surrounding environment of the vehicle and calculate and estimate parameters of the vehicle's surrounding environment.

8. The vehicle of claim 1, wherein said wireless sensor with IP address and said image sensor are used to monitor the vehicle surrounding environment, calculate and estimate the distance and approaching speed of objects in the surrounding environment of vehicle and use the information to make a better decision to activate said multilayer airbags.

9. The vehicle of claim 1, wherein said multilayer airbags are mounted on the main body frame of the vehicle to provide a firm and strong support.

10. The vehicle of claim 1, wherein said multilayer airbag provides protection by inflating “n” airbags that is within one another sequentially or simultaneously.

11. The vehicle of claim 1, wherein multiple multilayer airbags are mounted on all external sides of said vehicle to provide protection for impacts due to external objects on any external side of vehicle.

12. A moving object with a protection system comprising:
a plurality of sensors installed at location internal and external to the body of said moving object to provide an information data related to the operation and surrounding environment parameters of said moving object for a controller to process;
said protection system uses at least one of a plurality of expandable pads, a plurality of compressed air, a plurality of multilayer airbags;
said plurality of multilayer airbags are installed on the external body frame of said moving object;
said plurality of compressed airs have an outlet installed on the external body of said moving object;
said plurality of expandable pads are installed on the external body frame of said moving object;
said controller monitors said information data and decide when to activate at least one of multilayer airbag from said plurality of multilayer airbags, expandable pad from said plurality of expandable pads, and compressed air from said plurality of compressed airs;
said moving object is at least one of an automobile, a robot, a flying car, a drone, a small plane, a glider, a human and a moving device/equipment.

13. The moving object of claim 12, wherein said plurality of compress air is a centralized compressed air unit with a plurality of outlets at different sides of the flying object and the air is released only from the outlets on the side that flying object lands or crash to the ground.

14. The moving object of claim 12, wherein said controller configures itself based on configuration data stored in its memory and then starts executing the artificial intelligence software which controls all aspects of navigation and protection of the flying object.

15. The moving object of claim 12, wherein said expandable pad is a polymer that expands when a voltage is applied at its two ends.

16. The moving object of claim 12, wherein said multilayer airbag provides “n” layer of redundancy.

17. The moving object of claim 12, wherein a subset of airbags from said multilayer airbag is inflated sequentially or simultaneously.

18. The moving object of claim 12, wherein said plurality of sensors is at least one of image sensor, wireless sensor (radar), heat sensor, speed sensor, acceleration sensor, ultrasonic sensor, proximity sensor, pressure sensor, G sensor, and IR (infrared) sensor.

19. The moving object of claim 12, wherein one or more of the multilayer airbags at one or multiple sides of the flying object is inflated to make the crash or landing as smooth as possible.

20. The moving object of claim 12, wherein each sensor of said plurality of sensors has an IP address which is used to avoid collision or confusion of the information data received by the controller from sensors internal or external to the flying object.
